(19) United States
(12) Patent Application Publication
(10) Pub. No.: US 2013/0124648 A1
(43) Pub. Date: May 16, 2013

(54) Email Filtering Based on Social Networking Information

(71) Applicant: Gopinath Neelambaran Kallayil, Redwood Shores, CA (US)

(72) Inventor: Gopinath Neelambaran Kallayil, Redwood Shores, CA (US)

(73) Assignee: Google Inc., Mountain View, CA (US)

(21) Appl. No.: 13/298,216

(22) Filed: Nov. 16, 2011

(51) Int. Cl. G06F 15/16

(52) U.S. Cl. 709/206

(57) ABSTRACT

A system and machine-implemented method for automatically generating an email filter based on social networking groups, including receiving an indication of one or more social groups associated with a user, wherein each of the one or more social groups is associated with the user's account in a social networking service, determining, using the one or more computing devices, one or more contacts associated with each of the one or more social groups associated with the user at the social networking service, determining, using the one or more computing devices, one or more email addresses corresponding to each of the one or more contacts, generating an email filter according to the one or more email addresses and applying the generated email filter to an email list of a user.

### BACKGROUND

The subject disclosure generally electronic mail (“email”) management, and, in particular, to filters for managing email lists.

Email services provide users with filtering mechanisms for email and other messages. For example, users are able to select multiple email addresses, such that email messages received from those email addresses will be treated differently than other email messages (e.g., filtered out or kept in). However, it's usually burdensome to include every individual email address within a filter, especially where a large number of intended sender/recipients are desired to be included within the email filter and/or in situations where an intended sender/recipient has more than one email address. In such instances, the user would have to be aware of every email address used by the intended sender/recipient and will have to individually add each email address to the filter.

Furthermore, when the user intends to filter email messages associated with a specific group of people (e.g., work groups, family), the user has to create filters for the different groups individually adding the email address for each individual within the group to the filter. Furthermore, since the creation of such email filter may be burdensome, usually email filters with different combinations of intended sender/recipients cannot be created, and/or modified quickly, as may be desired by the user.

Thus, a quicker and more efficient method for generating email filters for managing a user email list may be desirable.

### SUMMARY

The disclosed subject matter relates to a method executed on one or more computing devices for automatically generating an email filter based on social networking groups, the method comprising receiving an indication of one or more social groups associated with a user, wherein each of the one or more social groups is associated with the user's account in a social networking service. The method further comprising determining, using the one or more computing devices, one or more contacts associated with each of the one or more social groups associated with the user at the social networking service. The method further comprising determining, using the one or more computing devices, one or more email addresses corresponding to each of the one or more contacts. The method further comprising generating an email filter according to the one or more email addresses and applying the generated email filter to an email list of a user.

The disclosed subject matter also relates to a system for automatically generating an email filter based on social networking groups, the system comprising one or more processors and a machine-readable medium comprising instructions stored therein, which when executed by the processors, cause the processors to perform operations comprising receiving a request from a user to generate a filter, the request including one or more social groups associated with the use. The operations further comprising identifying the one or more social groups in response to receiving the request, wherein each of the one or more social groups is associated with the user's account in a social networking service. The operations further comprising determining one or more contacts associated with each of the one or more social groups. The operations further comprising determining one or more email addresses associated with the one or more contacts. The operations further comprising generating an email filter including the one or more email addresses and generating a filtered email list by applying the generated email filter to an email list of a user, the filtered email list including one or more email messages from the one or more contacts.

The disclosed subject matter also relates to a machine-readable medium comprising instructions stored therein, which when executed by a machine, cause the machine to perform operations comprising receiving an indication of one or more social groups, wherein each of the one or more social groups is associated with the user's account in a social networking service, wherein each of the one or more social groups includes one or more contacts. The operations further comprising determining the one or more contacts associated with each of the one or more social groups. The operations further comprising determining one or more email addresses corresponding to each of the one or more contacts. The operations further comprising determining one or more priorities assigned to at least one of the one or more social groups, the one or more contacts and the one or more email addresses and generating an email filter according to the one or more email addresses and the one or more priorities for application to an email list of a user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for filtering email messages.

FIG. 2 illustrates a flow diagram of an example process for filtering email messages according to social networking information.

FIG. 3 illustrates a flow diagram of an example process for generating an email filter based on social groups.

FIG. 4 illustrates a flow diagram of an example process for sorting email messages according to sorting criteria.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The subject disclosure provides a method for managing email messages based on social groups. A user may select one or more social groups from one or more social networking services in which the user is a member. Upon receiving the user's selection, the system communicates with those social networking services to identify the one or more contacts within each of the indicated social groups. The system may further retrieve information, including one or more email addresses associated with each of the one or more contacts, from the social networking services. Additionally, the system may, upon identifying the one or more contacts, retrieve additional email addresses for the contact from one or more other sources (e.g., the contact list maintained by the email service and/or third party contact lists). The list of the identified contacts and the one or more email addresses for each of those contacts may be used by the system for various purposes including but not limited to managing email messages (e.g., creating mail filters, email lists, sorting email messages). For example, using the list, the system may automatically generate a filter including the email addresses retrieved for all contacts of the indicated social groups.

The subject disclosure further provides a method of managing email lists, including filtering or sorting email lists (e.g., once an the social group based email filter is generated and applied to the email messages) according to various user-specified and/or machine learned criteria. The criteria may include priority assigned to various social groups or individual contacts either explicitly by the user or based on historical behavior of the user with respect to the social groups or individual contacts. Such historical information may be retrieved from the social networking service (e.g., where the social networking service maintains such information or information from which such information may be drawn). For example, a user may be able to explicitly assign a priority to a specific social group or to specific contacts of a social group.

Furthermore, priorities may be assigned to social groups or individual contacts or specific email addresses based on the behavior of the user with respect to email messages from the contacts (e.g., an email address associated with a contact) within these groups (either dynamically and/or based on historical behavior). For example, the system may receive an indication of a user's interaction with email messages displayed to the user within an email list (e.g., displayed to the user within his/her mailbox or inbox), and may generate criteria for sorting the email list (e.g., before presenting the list to the user, or dynamically while the user is viewing the list). Such indication may for example include the order in which the user selects to read email messages within an email list (e.g., selecting email messages from a certain recipient first). The frequency of correspondence of a user with a contact or group, the longevity of a correspondence (i.e., length of mail thread), the time lapsed before response by the user. Such information may be collected on a one time basis for the specific email list being displayed, and/or historically maintained for future use. Furthermore, users may manually push an email message up or down a list, thus increasing or decreasing the priority of that email message. The indication of the change in priority may be used to generate or update sorting criteria for sorting email messages. The email sorting criteria may provide priority information for groups (e.g., social groups, email lists), individual users (e.g., contacts within social groups, or other contacts), email content, email subject or other email characteristics. Such sorting criteria may for example be used to sort the email list after a social group filter (including one or more social groups) is applied to a user's email list. However, the sorting method is not limited to such lists, and may be used with respect to any email list.

The phrase “email filtering” as used herein encompasses its plain and ordinary meaning, including, but not limited to, processing of email message to organize it according to specified criteria (hereinafter referred to as “filter criteria”). Filtering of email messages may include selecting a set of email messages for presentation to the user (e.g., from the entire collection of email messages with a user's mailbox), discarding a set of email messages, sorting email messages and/or otherwise organizing email messages. The filter criteria may include criteria entered by the user (e.g., including social groups), and/or machine-learned filter criteria (e.g., criteria derived from user interaction with email messages). In one example, users can make personal, “manual” filters (e.g., according to user input filter criteria and/or machine-learned filter criteria) that then automatically filter mail according to the chosen filter criteria. The phrase “sorting criteria” as used herein encompasses its plain and ordinary meaning, including, but not limited to, a set of filter criteria used for sorting email messages. Additionally, the sorting criteria may be further used for other filtering purposes (e.g., selecting or discarding a specific set of email messages).

The phrase “social networking service” as used herein encompasses its plain and ordinary meaning, including, but not limited to, an online service, platform or site that focuses on building and reflecting of social associations and interactions among users. These associations may be stored within a social graph at each social networking service (e.g., maintained at remote server(s) 120). Users of social networking services may create associations with one another. Such user associations may be defined on a user-to-user basis, or as a group of users associated through membership within a group. As used herein, “contacts” refer to other users that a user is associated with, at one or more social networking services.

A user may create “social groups” (e.g., social circles) including one or more contacts to organize his/her associations. The social groups may be additionally used to control distribution of messages and content to contacts of the user. For example, social groups may include categories to which a user can assign their social networking contacts and better control the distribution and visibility of social networking messages as well as other multimedia content (e.g., documents, and other collaboration objects). In accordance with the subject disclosure, a social group is provided as a data set defining a collection of contacts that are associated with one another. As used herein, a social group can be described from the perspective of an individual that is the center of a particular collection of socially interconnected people, or from the aggregate perspective of a collection of socially interconnected people. In some examples, a social group can have narrowly defined boundaries, all of the members of the social group may be familiar with one another, and permission may be required for a member to join a social group. In accordance with the subject disclosure, a user of an electronic device may define a social group, and the social group, as a data set defining a collection of contacts, may reflect a real-life social group of the user.

For example, a user of an electronic device may have different groups of friends, coworkers, and family, and there may be some overlap among those groups (e.g., a coworker who is also considered to be a friend, a family member who is also a coworker). Through the creation and use of social groups (e.g., social circles), the user can organize and categorize his/her contacts into various different groupings.

II. Example Client-Server Network Environment for Organizing Email Messages

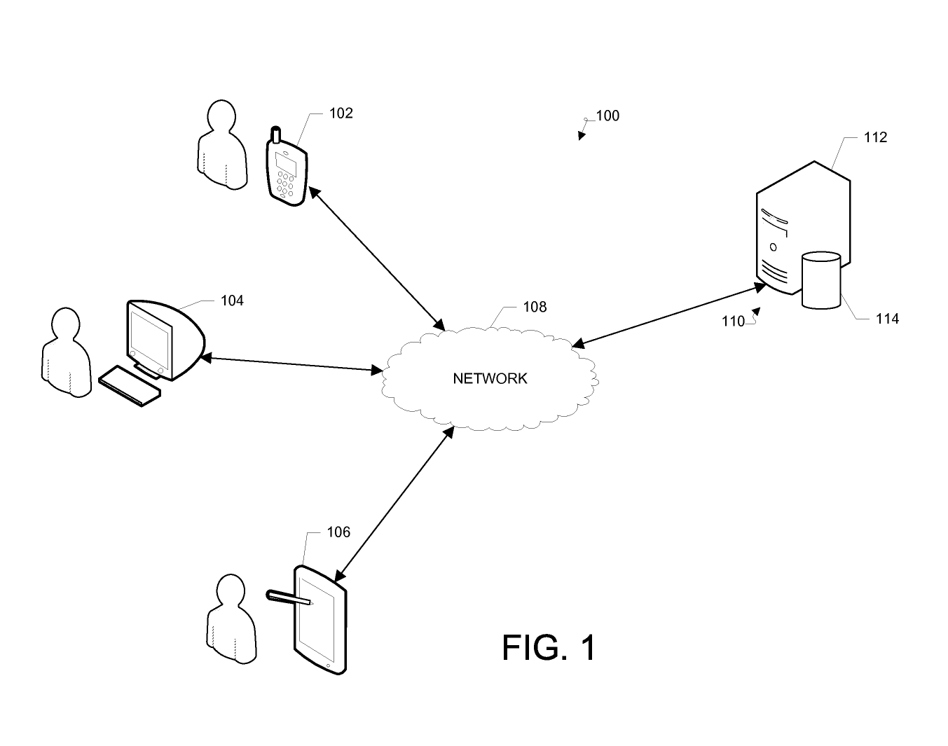

FIG. 1 illustrates an example client-server network environment which provides for organizing email messages. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, to assist in reducing load time for displaying a webpage or web application at electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host the present system and/or the email client. The present system (e.g., hosted at server 110) may be installed (e.g., by the user), either as separate system (e.g., a system communicationally coupled to the e-mail client) or as an integrated application within an email program (e.g., email client). In one example, the present system may be communicationally coupled to one or more email services (hosted at a remote server) through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Organizing Email Messages

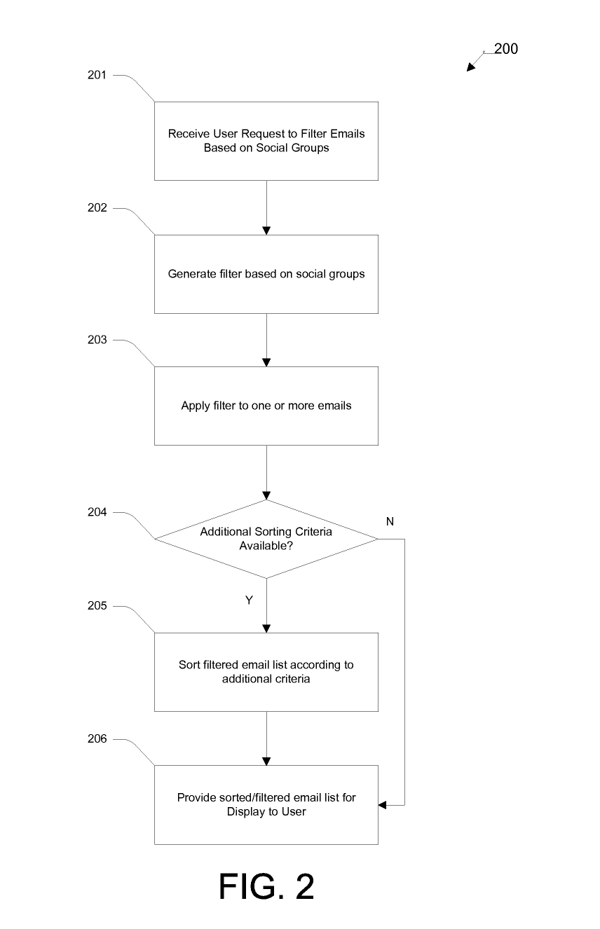

FIG. 2 illustrates a flow diagram of an example process 200 for filtering email messages according to social networking information. The process 200 begins in block 201 where the system receives a user request to filter email messages based on social groups. For example, the user may make a selection to filter his/her email messages (e.g., email messages within his/her inbox). The filter may be a filter to be applied to incoming email messages or a filter for email messages already received and presented to the user (e.g., within an email list sorted by time received). The user may then identify one or more social groups associated with the user's user account at one or more social networking services.

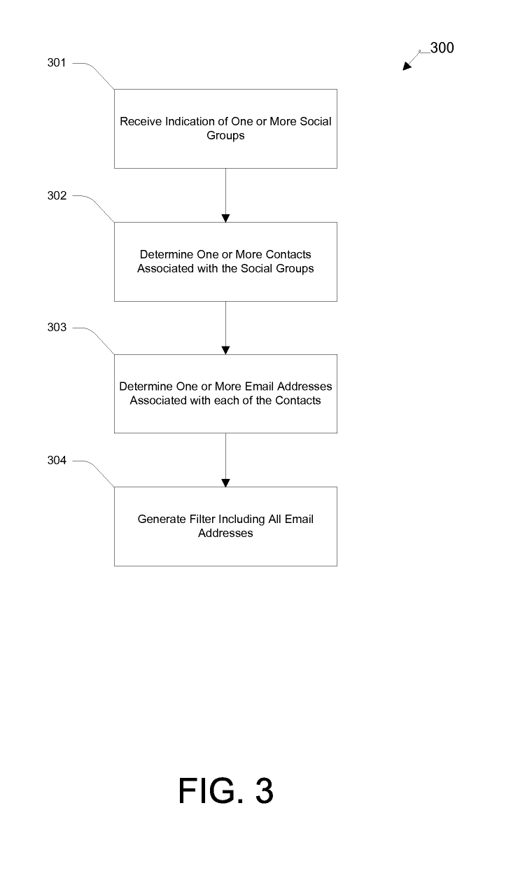

In block 202, the system generates a filter based on the social groups indicated by the user. In one example, the system may query the social networking service maintaining each of the social groups and request a listing of all contacts within the social group and/or contact information (e.g., email addresses) associated with the contacts (e.g., stored within the contact's profile or account) within the social group. Upon receiving this information from the social networking service, the system may further retrieve additional contact information (e.g., email addresses) associated with the contacts from one or more other sources accessible by the system through proper permission (e.g., user granted or system granted permissions). For example, the system may receive profile information associated with each contact from the social networking service, the profile information including means for identifying the contact (e.g., name, contact ID, contact email addresses). The system may use the profile information to identify the contact and may lookup the contact identifier to find other email addresses associated with the contact in one or more other contact lists maintained by one or more services other than the social networking service. Other resources, may for example include contact list(s) maintained by the email service, contact list(s) associated with the user at other email services, or other sources accessible by the system (with proper permissions) that maintain contact information regarding the identified contacts. The system may then generate an email filter using the retrieved email addresses. An example process 300 for generating an email filter based on social groups is described in further detail below with respect to FIG. 3.

Next, in block 203, the system applies the email filter generated in block 202 to the user's email messages (e.g., email messages within the mailbox of the user) and generates a filtered email list. For example, the system may select one or more email messages, discard one or more email messages and/or sort the email messages within the user's mailbox to generate the filtered list.

In block 204, the system may determine if there are additional sorting criteria available for further sorting of the filtered list of block 203. In one example, the system may have access to one or more sorting criteria for sorting email messages. For example, the sorting criteria may be provided by the user or may include machine-learned criteria. The sorting criteria may for example include priorities assigned to one or more social groups or one or more specific contacts or email addresses. Furthermore, the sorting criteria may include priority or preference assigned to a specific topic (e.g., specified within the subject or content of the email message), email context (time or date the email message was sent and/or received), and other similar email characteristics. These priorities may be explicitly assigned by the user, or may be assigned by the system based on historical information regarding the user's interaction with email messages associated with each of the one or more social groups, contacts or specific email addresses (e.g., email messages listing the one or more contacts of the social group as a sender or recipient). The determination in block 204 may depend on whether such information is available and/or whether the user has made an explicit request for additional sorting of the email list.

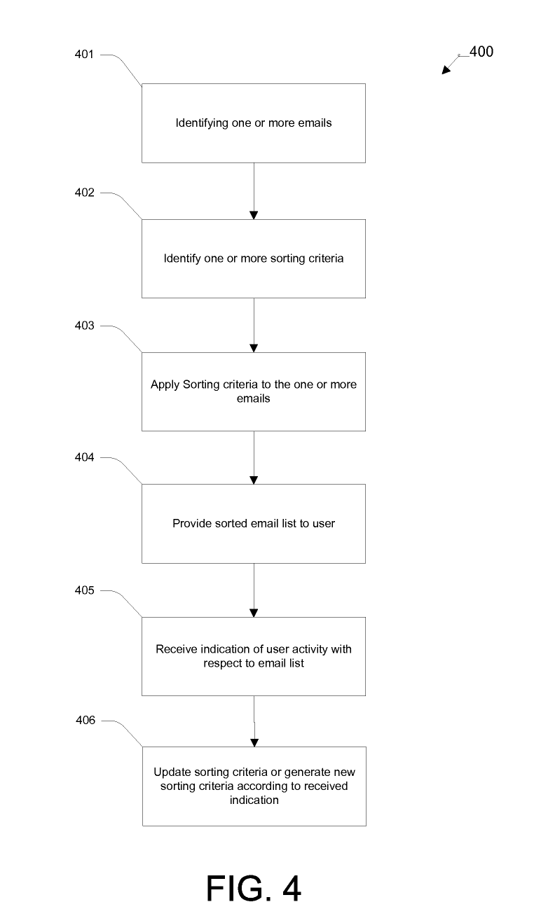

If, in block 204, it is determined that no additional sorting criteria is available (e.g., no sorting criteria is available or that the user has not requested additional sorting), the process continues to block 206. Otherwise, the process continues to block 205 and sorts the email messages (i.e. the filtered email messages) according to the sorting criteria. An example process 400 for sorting email messages according to sorting criteria is described in further detail below with respect to FIG. 4. After sorting the email messages, the process continues to block 206. In block 206, the system provides the filtered and/or sorted email list for display to the user.

In one example, the system may further provide for dynamic sorting (or filtering) of email messages once the list has been provided to the user. For example, the system may receive an indication of user action with respect to the email messages (e.g., deleting email messages, selecting email messages out of order, moving email messages down the list, etc.) and may dynamically generate updated (or additional) sorting (or filtering) criteria for further organizing the email list displayed to the user. The system may apply the updated sorting criteria to the displayed list and provide the user with an updated email list.

FIG. 3 illustrates a flow diagram of an example process 300 for generating an email filter based on social groups. In block 301, the system receives an indication of one or more social groups associated with the user's account at a social networking site. For example, a user may select one or more social groups for filtering his/her email list. In another example, the system may have priority information for one or more social groups associated with a user and may identify the social groups to automatically filter the user's email messages (e.g., based on a user or system setting). In block 302, the system determines one or more contacts associated with each of the one or more social groups. In one example, the social groups may be maintained within the social graph of a social networking service, and the system may query the social networking service (e.g., through an API call to the social networking service) to identify contacts are associated with the social group. The determined one or more contacts may include all contacts associated with a social group or those that have granted proper permissions to be identifiable in response to a query (e.g., a query by the system). One or more contacts of the user may opt out of being identified in response to a request to the social networking service. Additionally, the social networking service may allow users to opt into being identifiable by one or more applications (e.g., the system herein for email list filtering).

In block 303, the system determines one or more email addresses (or other similar contact information) associated with the one or more contacts. For example, the system may send a request to the social networking service to receive one or more email addresses associated with the contact account of the contact. In another example, the request may be sent along with, or as part of, the query for the associated contacts sent in block 302. Furthermore, the system may identify additional email addresses belonging to an identified contact from one or more additional sources (e.g., contact list(s) maintained by the email service, contact list(s) associated with the user at other email services, or other sources accessible by the system through proper permissions). In one example, in block 303, the system may generate a list of email addresses, where each contact of the one or more social groups identified in block 301 is associated with one or more email addresses.

Next, in block 304, the system generates an email filter which includes all of the email addresses identified in block 303. In one example, the generated email filter may include the email addresses, where some or all of the email addresses are given a specific preference or priority. These priorities may be assigned by the user explicitly, or may be machine-learned priorities based on the user's actions (e.g., at the social networking service or email service) with respect to each social group, contact or individual email addresses or email messages listing the contacts as recipients or senders. There priority or preference may be used in the filtering process to sort or otherwise organize the email messages filtered using the generated email filter.

FIG. 4 illustrates a flow diagram of an example process 400 for sorting email messages (e.g., within a user's mailbox) according to sorting criteria. The process begins in block 401 where the system identifies one or more email messages. The email messages may include incoming email messages, or email messages being provided for display to a user. Next, in block 402, the system identifies one or more sorting criteria. For example, the sorting criteria may be provided by the user and/or may include machine-learned sorting criteria. The sorting criteria may include priorities assigned to one or more “email components”. Email components may include various elements associated with an email message such as the email sender (e.g., email address, contact account or social group associated with the sender), email recipients (email addresses, contact account or social groups associated with recipients in the TO:, CC: or BCC: fields), an email topic (e.g., determined from the email subject line or by parsing the email content), and email context information (e.g., time, date, location).

In one example, the sorting criteria may include priorities assigned to one or more social groups or one or more specific contacts or one or more email addresses. Furthermore, the sorting criteria may include priority or preference assigned to a specific topic (e.g., specified within the subject or content of the email message), email context (time or date), and other similar email characteristics. These priorities may be explicitly assigned by the user, or may be assigned by the system based on the user's interaction with email messages or email lists (e.g., user interaction with email messages from each of the one or more social groups, contacts, specific email addresses, email messages regarding specific topics, or email messages sent during a specific time or date).

User interactions which may be used to generate the sorting criteria (e.g., priorities or preferences) described above may be based upon user actions, and may include one or both historical information and information regarding the user's actions with respect to an email list being presently displayed to the user. Example user actions which may be used to generate sorting criteria (i.e. machine-learned sorting criteria) may include the order in which the user selects to read email messages within an email list (e.g., selecting email messages from a certain recipient first). The frequency of correspondence of a user with a contact or group, the longevity of a correspondence (i.e., length of mail thread), the time lapsed before response by the user. Furthermore, users may manually push an email message up or down a list, thus increasing or decreasing the priority of that email message. The indication of the change in priority may be used to generate sorting criteria for sorting email messages.

In block 403, the system applies the sorting criteria to sort the identified one or more email messages according to the identified sorting criteria. For example, the system determines the email address(es), contact(s), and/or social group(s) associated with each of the one or more email messages, and ranks the one or more email messages according to the priorities assigned to social groups, contacts or email addresses. In one example, the system further determines a topic and/or context information (e.g., time and date) for each of the email messages and further ranks the one or more email messages according to priorities assigned to various topics or context information.

In one example, the sorting criteria may be applied to the one or more email messages (e.g., user's mailbox) based on a request or setting by the user, a request or setting by the email service, or may be automatically applied by the system. In one example, the sorting criteria may further depend on the time and date that the sorting is performed. For example, the sorting information may be time or date dependent, such that the system applies different sorting criteria based on the time and date that the user requests to view his/her email messages. The sorting criteria may be applied to already displayed email lists (e.g., to dynamically sort the displayed email list based on historical or proximate user action), or may be applied to incoming email messages, or before an email list is presented to a user. In one example, one or more of the above described sorting criteria (e.g., priorities or preferences) may be assigned a weight (e.g., by the system or by the user), and the sorting may be based upon one or more of the sorting criteria based upon the weight associated with the each of the one or more criteria.

In block 404, the sorted email list is provided for display to the user. In one example, where the sorting criteria are applied to an already displayed email list, the sorted email list is used to update or replace the existing email list being displayed to the user. As described above, in one example, user interaction with regard to email messages may be received by the system and analyzed to generate or update sorting criteria. Thus, in one example, after providing the email message for display, in block 405, the system receives an indication of user activity with respect to the email list (e.g., an action with respect to one or more email messages within the email list). In block 406, the system uses the received indication to generate new sorting criteria or update existing sorting criteria (e.g., weights assigned to specific sorting criteria). In one example, the system may further use the received indication of user activity to dynamically update the email list provided for display to the user in block 404 or may store the received indication as historical information.

It should be understood by one of ordinary skill in the art that while the example process 400 is described with respect to sorting email messages, similar criteria may be used to filter or otherwise organize email messages. While the criteria are referred to herein as sorting criteria, the disclosed criteria may be used for any email management or organization purposes including sorting or filtering email messages. Additionally, while the subject disclosure refers to email messages viewed within an email service mailbox, it should be understood by one of ordinary skill in the art, that the above processes may be implemented with respect to any email messages, messages, or other communication (e.g., text messages, voicemail messages) for organizing such communication for presentation to the user, and may include use of other contact information in addition to email addresses (e.g., phone number, user account identifiers) where such contact information may be used to organize communication provided for display to the user.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

IV. Example System for Organizing Email Messages

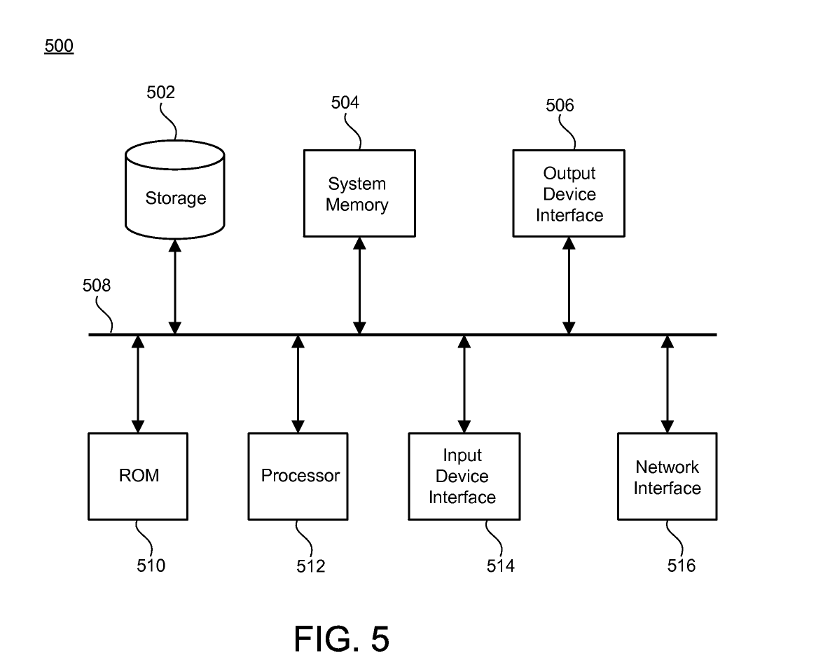

FIG. 5 conceptually illustrates an electronic system with which some implementations of the subject technology are implemented. Electronic system 500 can be a computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for filtering email messages according to various embodiments. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method executed on one or more computing devices for automatically generating an email filter based on social networking groups, the method comprising:
receiving an indication of one or more social groups associated with a user, wherein each of the one or more social groups is associated with the user's account in a social networking service;
determining, using the one or more computing devices, one or more contacts associated with each of the one or more social groups associated with the user at the social networking service;
determining, using the one or more computing devices, one or more email addresses corresponding to each of the one or more contacts;
generating an email filter according to the one or more email addresses; and
applying the generated email filter to an email list of a user.

2. The method of claim 1, further comprising:
generating a filtered email list in response to the applying, the filtered email list including one or more email messages from the one or more contacts.

3. The method of claim 2, further comprising:
sorting the one or more email messages of the filtered list according to one or more sorting criteria; and
generating a sorted email list in response to the sorting, the sorted email list including the one or more email messages.

4. The method of claim 3, wherein the sorting criteria include one or more priorities assigned to one or more email components associated with an email message, and
wherein the sorting process comprises:
identifying a priority assigned to one or more email components associated with each of the one or more email messages of the filtered list; and
ranking the one or more email messages of the filtered list according to the priorities.

5. The method of claim 4, wherein the one or more components include one or more of an email address a contact or a social group associated with an email message.

6. The method of claim 4, wherein the one or more components include a topic of the email message, wherein the topic of the email message is defined by one or more of the subject line of the email message or the content of the email message.

7. The method of claim 4, wherein the one or more components include at least one of the time or the date that the email message was sent.

8. The method of claim 4, wherein the one or more priorities are assigned by the user.

9. The method of claim 4, wherein the priorities are assigned based on the user's interaction with a set of email messages.

10. The method of claim 9, wherein the set of email messages includes the one or more email messages of the filtered list.

11. The method of claim 3, further comprising:
providing the sorted email list for display to the user; and
receiving an indication of user activity with response to the email list.

12. The method of claim 11, further comprising:
updating the sorting criteria in response to receiving the indication; and
generating an updated email list by sorting the sorted email list according to the updated sorting criteria.

13. The method of claim 1, wherein the determining the one or more contacts comprises:
sending a request for contacts associated with each of the one or more selected social groups to the social networking service associated with the social group; and
receiving the one or more contacts associated with each of the one or more selected social groups.

14. The method of claim 1, wherein determining the one or more email addresses comprises:
identifying one or more email addresses associated with the contact account of each of the one or more contacts at the social networking service associated with the contact account of the contact; and
identifying one or more additional email addresses associated with the contact at one or more contact lists associated with the user.

15. The method of claim 1, wherein identifying the one or more social groups comprises receiving a user request from the user including the one or more social groups.

16. A system for automatically generating an email filter based on social networking groups, the system comprising:
one or more processors; and
a machine-readable medium comprising instructions stored therein, which when executed by the processors, cause the processors to perform operations comprising:
receiving a request from a user to generate a filter, the request including one or more social groups associated with the user;
identifying the one or more social groups in response to receiving the request, wherein each of the one or more social groups is associated with the user's account in a social networking service;
determining one or more contacts associated with each of the one or more social groups;
determining one or more email addresses associated with the one or more contacts;
generating an email filter including the one or more email addresses; and
generating a filtered email list by applying the generated email filter to an email list of a user, the filtered email list including one or more email messages from the one or more contacts.

17. The system of claim 16, the operations further comprising:
sorting the one or more email messages of the filtered list according to one or more sorting criteria; and
generating a sorted email list in response to the sorting, the sorted email list including the one or more email messages.

18. The system of claim 1, wherein determining the one or more email addresses comprises:
identifying email addresses associated with the contacts associated with each of the one or more social groups from the social networking service associated with the social group;
identifying one or more additional contact lists associated with the user maintained by one or more services other than the social networking service; and
identifying additional email addresses associated with the one or more contacts maintained at the one or more additional contact lists.

19. A machine-readable medium comprising instructions stored therein, which when executed by a machine, cause the machine to perform operations comprising:
receiving an indication of one or more social groups, wherein each of the one or more social groups is associated with the user's account in a social networking service, wherein each of the one or more social groups includes one or more contacts;
determining the one or more contacts associated with each of the one or more social groups;
determining one or more email addresses corresponding to each of the one or more contacts;
determining one or more priorities assigned to at least one of the one or more social groups, the one or more contacts and the one or more email addresses; and
generating an email filter according to the one or more email addresses and the one or more priorities for application to an email list of a user.

20. The machine-readable medium of claim 19, the operations further comprising:
applying the generated email filter to one or more emails associated with the user; and
generating a filtered email list in response to the applying, the filtered email list including one or more email messages from the one or more contacts.

21. The machine-readable medium of claim 19, wherein determining the one or more email addresses comprises:
determining email addresses associated with the one or more contacts maintained at the social networking service associated with the social group;
determining one or more additional contact lists associated with the user maintained by one or more services other than the social networking service; and
determining additional email addresses associated with the one or more contacts maintained at the one or more additional contact lists.
